(19) United States
(12) Patent Application Publication
(10) Pub. No.: US 2016/0126730 A1
(43) Pub. Date: May 5, 2016

(54) CURRENT SENSE TECHNIQUES IN A POWER SUPPLY SYSTEM

(71) Applicant: Intel Corporation, Santa Clara, CA (US)

(72) Inventors: TARUN MAHAJAN, Beaverton, OR (US); SANTOSH NENE, Bangalore (IN)

(73) Assignee: Intel Corporation, Santa Clara, CA (US)

(21) Appl. No.: 14/533,536

(22) Filed: Nov. 5, 2014

(51) Int. Cl. H02J 1/00

(52) U.S. Cl. CPC H02J 1/00

(57) ABSTRACT

Generally, this disclosure describes a system for sensing current in a power supply system. The apparatus includes controller circuitry to select a first power supply of a plurality of power supplies, determine a reference output voltage (Voutr) associated with a reference supply based, at least in part, on a duty cycle (D) and an input voltage (Vin), D and Vin related to the first power supply. The controller circuitry is further to determine an output voltage (Voutx) associated with the first power supply, determine an effective resistance (Reffx) associated with the first power supply based, at least in part, on a present temperature, and determine an output current (Ioutx) associated with the first power supply based, at least in part, on Voutr, Voutx and Reffx.

### FIELD

The present disclosure relates to current sense techniques in a power supply system.

### BACKGROUND

Battery powered portable devices, including, for example, smartphones, tablet computers, etc., are typically configured to generate a plurality of supply voltages (“supply rails”) using a plurality of power supplies (e.g., DC/DC converters) within the device. Input power to the power supplies is provided by the battery. In order to optimize battery life, a power management unit (PMU) may be configured to monitor the current being drawn from each supply rail and to adjust operation of the associated power supply based on this information.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a power supply system consistent with various embodiments of the present disclosure;

FIG. 2 illustrates an example Buck converter topology and sensor circuitry according to one embodiment of the present disclosure;

FIG. 3A illustrates a lookup table (LUT) according to one embodiment of the present disclosure;

FIG. 3B illustrates a lookup table (LUT) according to one embodiment of the present disclosure;

FIG. 3C illustrates another lookup table (LUT) according to another embodiment of the present disclosure;

FIG. 3D illustrates an example calibration setup used for populating the LUTs of FIG. 3B and/or FIG. 3C consistent with various embodiments of the present disclosure;

FIG. 4 illustrates an example output current logic circuitry according to one embodiment of the present disclosure;

FIG. 5 is a flowchart of calibration operations according to one embodiment of the present disclosure; and

FIG. 6 is a flowchart of current sense operations according to one embodiment of the present disclosure.

Although the following Detailed Description will proceed with reference being made to illustrative embodiments, many alternatives, modifications, and variations thereof will be apparent to those skilled in the art.

### DETAILED DESCRIPTION

In some configurations, the PMU (power management unit) may be integrated with a portable device System-on-Chip (SoC) while the power supplies may be implemented within the portable device external to the SoC. Such a configuration may enhance current distribution within the device rather concentrating it in one region. In some configurations, a plurality of power supplies may be included in an integrated circuit (IC) such as a PTIC (power-train IC) and a plurality of PTICs may be included in the portable device.

Conventional current sensing typically includes sensing a differential voltage across a resistance such as a sense resistor and/or an inductor (e.g., inductor DC resistance) included in output power circuitry associated with each power supply. Thus, each sensed voltage may utilize a pair of nodes (e.g., pins) on a respective power supply. Each pair of nodes may be coupled to a respective resistor divider (e.g., voltage divider) to reduce the sensed voltage to within an input voltage range of the PMU. Each reduced sensed voltage may then be provided to an additional pair of nodes (e.g., pins) on the SoC.

Thus, implementing conventional current sensing with power supplies external to the SoC that includes the PMU may result in an increased pin count for both the SoC and the power supply ICs. Increased pin count can add both to both cost and size for both the SoC and the power supply ICs. Further, individual resistive dividers may introduce error into relative sensed currents due to variation and/or mismatch in resistor values between the voltage dividers.

Generally, this disclosure describes systems, methods and apparatus for current sense techniques in a power supply system. The power supply system may include controller circuitry, a plurality of power supplies and a reference power supply (reference supply). The controller circuitry is configured to determine an output voltage (Voutx) of a selected power supply, an output voltage (Voutr) of the reference supply and an effective resistance (Reffx) associated with the selected power supply. Voutr may be determined by controlling the reference supply with a PWM (pulse width modulation) signal associated with the selected power supply. The PWM signal may have a duty cycle Dx. The reference supply may be supplied with an input voltage Vinx corresponding to the input voltage of the selected supply and may be configured to operate open loop with no load (i.e., zero or relatively very small load current). Voutr may then correspond to Dx*Vinx. The controller circuitry is then configured to determine the output current (Ioutx) of the selected power supply as:

Ioutx=(Dx*Vinx−Voutx)/Reffx.

The character “x” in the above refers to the selected power supply. Thus, for a system with a number n power supplies, x is in the range of one to n. Ioutx may be determined for each of the n power supplies.

Reffx is related to one or more resistance parameters (R0, R1) that are related to power supply topology and output power circuitry characteristics, as described herein. The resistance parameters may vary with operating temperature. The resistance parameters and/or resistance parameter sensitivity to temperature variation may also vary with manufacturing process variation. Manufacturing process variation may affect other characteristics of each power supply and associated output power circuitry. Manufacturing process variation effects may be captured in testing (during and/or after manufacturing) and each power device (i.e., each power supply and associated output power circuitry) may then be classified according to one or more power device characteristics. Such classification may be identified by a classification identifier (ID) that is associated with particular ranges of values for selected power device characteristics. An appropriate classification ID may then be associated with each power supply. Thus, the resistance parameters and/or resistance parameter sensitivity to temperature for each power device may be related to the classification ID.

In some embodiments, the resistance parameters may be determined by a calibration operation. The calibration operation may include determining resistance parameter values for one or more temperatures for a number of power devices of each classification ID. The resistance values and temperature sensitivity parameters may be stored as entries in a lookup table (LUT). Thus, the LUT entries may include values and/or identifiers associated with temperature, classification IDs and resistance parameters whose values may vary with temperature and/or classification ID.

During operation, a present temperature may be sensed and/or detected for a selected power supply. The controller circuitry may then select associated resistance parameters from the LUT and determine Reffx based, at least in part, on one or more resistance parameter(s) from the LUT, as will be described in more detail below.

The plurality of power supplies may be coupled to the controller circuitry by at least one bus. The controller circuitry is configured to select one power supply for a current sensing operation and to then select each other power supply in a sequential, round robin fashion. The power supply system further includes common voltage divider circuitry. Each power supply and the reference supply may be selectively coupled to the common voltage divider circuitry via a bus. The common voltage divider circuitry is configured to divide (i.e., scale) a sensed voltage into a scaled voltage that is within an input voltage operating range of the controller circuitry. An output of the common voltage divider circuitry is coupled to an input of the controller circuitry.

Thus, a system, method and apparatus, as described herein, are configured to provide relatively accurate output (i.e., load) current sensing for a plurality of power supplies. Voutr is configured to provide present value of Dx*Vinx to account for any variation in Vin and to thus improve accuracy of the Ioutx determination. Reffx determination based, at least in part, on calibration data included in the LUT, detected present temperature and/or classification ID is configured to further improve accuracy by accounting for variation in Reffx related to temperature and/or classification ID. Utilizing common voltage divider circuitry for all sensed voltages Voutx, Voutr eliminates mismatch in resistor values that may be associated with individual voltage divider circuitries and that may affect the accuracy of sensed current. Coupling the common voltage divider circuitry to the controller circuitry may be accomplished by a relatively small number of pins (e.g., one or two), thus, avoiding significantly increasing the pin counts of the controller circuitry and the power supply ICs.

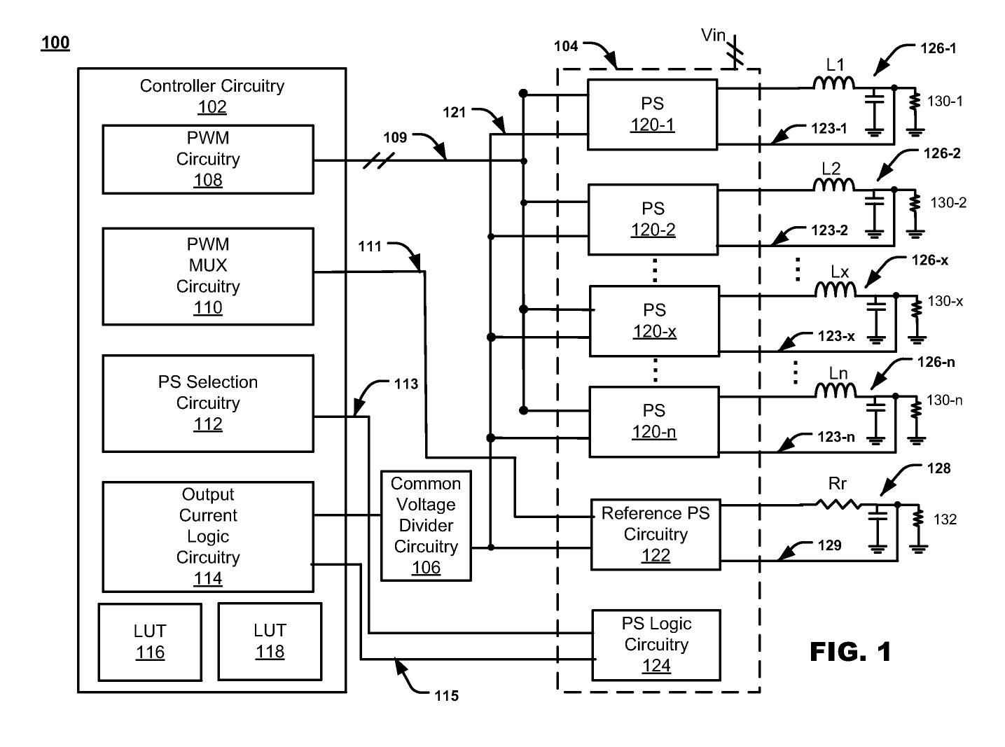

FIG. 1 illustrates a power supply system 100 consistent with various embodiments of the present disclosure. Power supply system 100 generally includes controller circuitry 102 configured to control power supply circuitry 104. The power supply circuitry 104 may include at least one power supply 120-1, 120-2, . . . , 120-x, . . . , 120-n and reference supply circuitry 122. At least one power supply 120-1, 120-2, . . . , 120-n, e.g., power supply 120-x, may include a switched DC/DC converter power supply topology, for example, known and/or after-developed switches DC/DC converter topology such as Buck, boost, Buck-boost, SEPIC (single-ended primary inductor converter), Class D, etc. Each power supply 120-1, 120-2, . . . , 120-n may be configured to operate using a pulse width modulation (PWM) signal and/or a pulse frequency modulation (PFM) signal, configured to generate an output voltage based on an input voltage Vin. Vin, as shown in FIG. 1 may be represented as a bus of different voltage values Vinx, and each power supply 120-1, 120-2, . . . , 120-n, e.g., power supply 120-x, may be coupled to a selected input voltage Vinx to generate an output voltage. The reference supply circuitry 122 may be formed of a similar topology and operate in a similar manner as any one of power supplies 120-1, 120-2, . . . , 120-n.

Each power supply 120-1, 120-2, . . . , 120-x, . . . , 120-n may be coupled to output power circuitry 126-1, 126-2, . . . , 126-x, . . . , 126-n, respectively. Output power circuitry 126-1, 126-2, . . . , 126-x, . . . , 126-n may include respective inductor circuitry L1, L2, . . . , Lx, . . . , Ln and respective output capacitor circuitry (shown but not labelled), for example, as may be utilized in a DC/DC converter topology such as Buck and boost, etc. An output voltage 123-1, 123-2, . . . , 123-x, . . . , 123-n of each respective output power circuitry 126-1, 126-2, . . . , 126-x, . . . , 126-n may be generated at the output of each respective inductor circuitry L1, L2, . . . , Lx, . . . , Ln and fed back to each respective power supply 120-1, 120-2, . . . , 120-x, . . . , 120-n. The output voltage may be referred to herein as Voutx, where “x” represents the output voltage of a selected power supply 120-1, 120-2, . . . , 120-x, . . . , 120-n, e.g., power supply 120-x. Each respective output power circuitry 126-1, 126-2, . . . , 126-n may be coupled to, and deliver power to, a respective load 130-1, 130-2, . . . , 130-x, . . . , 130-n.

Reference supply circuitry 122 may be coupled to reference output power circuitry 128, which may include a reference load 132 to generate an output voltage 129 (Voutr) that is fed back to reference supply circuitry 122. The reference load 132 is configured to draw load current at or near zero, i.e., no load during determination of an offset between Voutx and Voutr. During determination of resistance parameters R0, R1, a relatively higher average load current may be used. The reference supply circuitry 122 is further configured to provide Voutr to common voltage divider circuitry 106 and thereby, to output logic current circuitry 114, as described herein. In one example embodiment, reference output power circuitry 128 may include a resistor Rr in place of an inductor to reduce a size of reference output power circuitry 128. In another example embodiment, e.g., when cost is relatively less of a concern, the inductor may be retained and resistor Rr is not used. Each power supply 120-1, 120-2, . . . , 120-n and reference supply circuitry 122 may include one or more power switch devices (e.g., MOSFET switches) and driver circuitry configured to control the operational state of the power switch devices, as will be described in greater detail below.

The power supply circuitry 104 may also include power supply logic circuitry 124 configured to control the individual power supplies 120-1, 120-2, . . . , 120-n and the reference supply 122, and to exchange commands and data with the controller circuitry 102, as will be discussed in greater detail below. In general, the logic circuitry 124 is configured to couple an output voltage 123-1, 123-2, . . . , 123-n and/or 129 to bus 121 to provide output voltage information as feedback to the controller circuitry 102. Each power supply 120-1, 120-2, . . . , 120-n may have an associated power supply identifier (PS ID) configured to uniquely identify each power supply 120-1, 120-2, . . . , 120-n in the power supply circuitry 104. Each power supply 120-1, 120-2, . . . , 120-n may further have an associated classification ID. For example, the PS ID and classification ID may be set at manufacturing. Logic circuitry 124 may be configured to read each PS ID and each associated classification ID and to provide the PS ID and/or classification ID information for each power supply 120-1, 120-2, . . . , 120-n to controller circuitry 102. PS ID and associated classification ID may be provided, e.g., upon system 100 power up, at manufacturing and/or during operation. Controller circuitry 102 may be configured to store each PS ID and respective associated classification ID in a lookup table, e.g., LUT 118. Controller circuitry 102 may then utilize a respective PS ID to select a power supply for sensing output current, as described herein. Also, logic circuitry 124 may be configured to gather information and operational parameters concerning the power supplies 120-1, 120-2, . . . , 120-n and/or the reference supply circuitry 122, which may include, for example, temperature information, etc. Logic circuitry 124 may be configured to provide information and/or operational parameter(s) to controller circuitry 102 via bus 113 and/or bus 115.

The power supply circuitry 104 may be embodied as a driver and MOSFET module (DrMOS) where the power supplies 120-1, 120-2, . . . , 120-n, reference supply circuitry 122 and/or the logic circuitry 124 may be embodied as integrated MOSFET designs. In other embodiments, the power supply circuitry 104 may be implemented using modular power train integrated circuits (PTICs) with each power supply representing a slice of common die. In these embodiments, power supply circuitry 104 may include a plurality of logic circuitries 124. One logic circuitry 124 may be provided for each of a plurality of subsets of power supplies 120-1, 120-2, . . . , 120-n. For example, each PTIC may include a subset of power supplies 120-1, 120-2, . . . , 120-n and one associated logic circuitry 124. The plurality of logic circuitries 124 may be selectively coupled to controller circuitry 102 by a bus 113. In some embodiments, bus 113 and bus 115 may be a same bus.

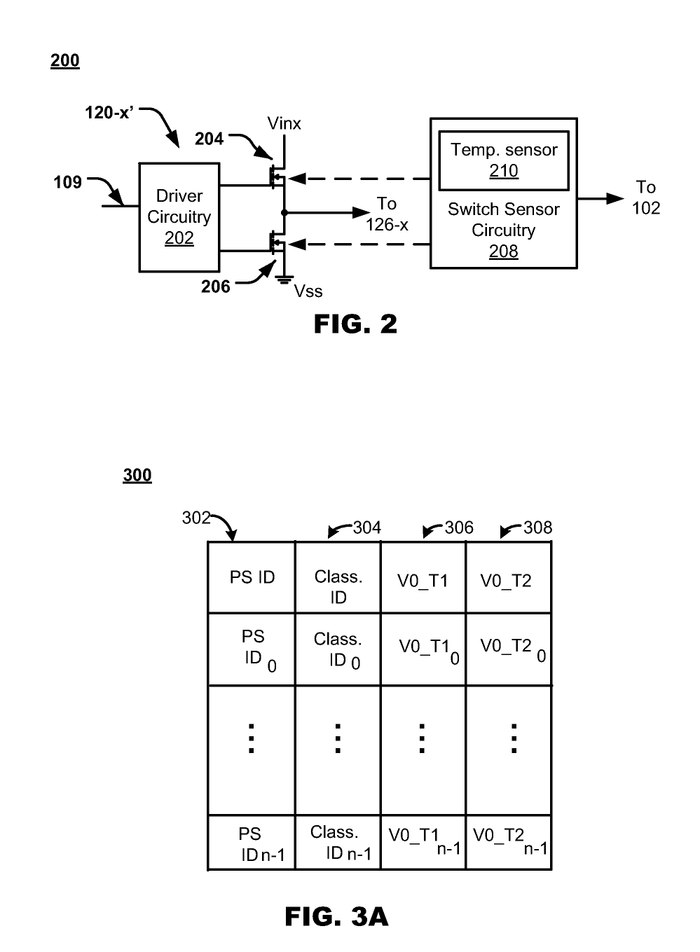

FIG. 2 illustrates an example 200 power supply topology 120-x′ and switch sensor circuitry 208 according to one embodiment of the present disclosure. Power supply topology 120-x′ is an example of any of power supplies 120-1, 120-2, . . . , 120-x, . . . , 120-n and may correspond to reference supply circuitry 122 of FIG. 1. In this example, the power supply topology 120-x is a Buck DC/DC converter that includes driver circuitry 202 configured to receive the PWM/PFM signal 109 and control the conduction state of a highside switch 204 and a lowside switch 206 based on the signal 109.

Driver circuitry 202 is configured to provide control signals related to received PWM/PFM signals 109 to respective gates of highside switch 204 and lowside switch 206. For example, highside switch 204 and lowside switch 206 may be MOSFETS (metal-oxide semiconductor field effect transistors). A drain of highside switch 204 is coupled to input voltage Vinx. A source of highside switch 204 is coupled to a drain of low side switch 206 and to output power circuitry 126-1 of FIG. 1. A source of lowside switch is coupled to Vss (e.g., ground). In operation, driver circuitry 202 is configured to control respective conduction states of switches 204, 206, switching between and “ON” state and an “OFF” state. A respective drain-source resistance of each switch 204, 206 may be generally very high when the respective switch is in the OFF state. The respective drain source resistance of each switch may be relatively low when the respective switch is in the ON state. Herein, Rds_highside is the drain-source ON resistance of high side switch 204 and Rds_lowside is the drain-source ON resistance of the lowside switch 206.

Example 200 further includes switch sensor circuitry 208. Switch sensor circuitry 208 is configured to detect operational parameter(s) related to switches 204, 206. For example, switch sensor circuitry 208 may include a temperature sensor 210 configured to detect a present temperature of switches 204, 206. Temperature sensor 210 may be further configured to sense over-temperature fault conditions. Switch sensor circuitry 208 is configured to provide detected temperature to controller circuitry 102.

For example, switch sensor circuitry 208 may detect a present temperature of high side switch 204 and/or low side switch 206. Such temperature detection may be performed periodically, generally, no more frequently than each determination of Ioutx. In other words, since temperature may change relatively slowly, periodic temperature detection may be performed less frequently than Ioutx determination. The detected temperature may then be provided to output current logic circuitry 114 via bus 115 for storage and/or determination of Ioutx.

Turning again to FIG. 1, the power supply system 100 may also include common voltage divider circuitry 106 configured to receive an output voltage 123-1, 123-2, . . . , 123-n from at least one power supply 120-1, 120-2, . . . , 120-n and/or the reference supply circuitry 122, via bus 121, and provide an output voltage level that is within an input voltage operating range of the controller circuitry 102. The common voltage divider circuitry 106 permits the controller circuitry 102 to obtain output voltage information (and thus, as will be explained below, output current information) for multiple power supplies using a single integrated circuit (IC) pin of the controller circuitry 102. Further, the common voltage divider circuitry eliminates mismatch that may occur between individual voltage divider circuitries.

Controller circuitry 102 may be embodied as an integrated circuit (IC) package (e.g., SoC, etc.) having a defined number of package pins. Increasing the number of pins to enable reading of the output current of multiple power supplies may not be feasible in some instances, or may prohibitively increase the cost and/or size of the IC. Thus, the present disclosure provides controller circuitry 102 that is configured to reduce or eliminate the need for additional pins to read output current for multiple power supplies.

The controller circuitry 102 may include PWM circuitry 108 configured to generate at least one PWM signal 109 and/or PFM signal (109) to control one or more power supplies 120-1, 120-2, . . . , 120-n and/or reference supply circuitry 122. In some embodiments, each power supply 120-1, 120-2, . . . , 120-n and reference supply circuitry 122 may be controlled by separate PWM/PFM signals 109, and thus, PWM circuitry 108 may be configured to generate a plurality of PWM signals, one for each of the power supplies 120-1, 120-2, . . . , 120-n. Each PWM signal 109 may have a duty cycle, D, which may be independent of the duty cycle of other PWM signals. An output voltage of each power supply 120-1, 120-2, . . . , 120n is related to the duty cycle, D. Controller circuitry 102 may also include PWM multiplexer (MUX) circuitry 110 configured to couple at least one PWM/PFM signal 109 generated by the PWM circuitry 108 to the reference supply circuitry 122, via bus 111.

Controller circuitry 102 may also include power supply selection circuitry 112. Selection circuitry 112 is configured to exchange commands and data with the logic circuitry 124 to select at least one power supply 120-1, 120-2, . . . , 120-n and/or reference supply circuitry to enable a read of an output voltage Voutx and/or Voutr. For example, data may include respective PS IDs, as described herein. In addition, selection circuitry 112 is configured to poll the power supply circuitry 104 to gather information and operational parameters concerning the power supplies 120-1, 120-2, . . . , 120-n and/or the reference supply circuitry 122, which may include, for example, temperature information, etc. Power supply selection circuitry 112 may also be configured to control the PWM MUX circuitry 110 to couple a PWM/PFM signal 109 to the reference supply circuitry 122, as will be described in greater detail below.

Controller circuitry 102 may also include output current logic circuitry 114 that is generally configured to determine an output current (Ioutx) of a power supply 120-1, 120-2, . . . , 120-n, based, at least in part, on the output voltages Voutx and Voutr. The output voltages Voutx and Voutr are each supplied to the output current logic circuitry 114 sequentially via the common voltage divider circuitry 106. Thus, the controller circuitry 102 is configured to gather sufficient information to determine an output voltage for a plurality of power supplies using, at least in part, the common output voltage bus 121 and the common voltage divider circuitry 106. In other words, the output voltage from each of the power supplies 120-1, 120-2, . . . , 120-n and/or the reference supply circuitry 122 may be supplied to the controller circuitry 102 using a single package pin.

In example embodiments, output current logic circuitry 114 may determine the output current (Ioutx) of a power supply, e.g., power supply 120-x, among the plurality of power supplies 120-1, 120-2, . . . , 120-n using the following equation:

Ioutx=(D*Vinx−Voutx)/Reffx;

where Dx is the duty cycle of a PWM/PFM signal 109 supplied to a selected power supply (e.g., power supply 120-x); Vinx is the input voltage of the selected power supply 120-x and Dx*Vinx is determined from the reference supply circuitry 122 and reference output circuitry 128 as Voutr 129. In other words, Dx*Vinx=Voutr. Voutx is the output voltage 123-x of the selected power supply 120-x and output power circuitry 126-x. Reffx is the effective resistance associated with the selected power supply 120-x and output power circuitry 126-x.

In some embodiments, a calibration operation may be performed configured to measure an offset voltage that may be present between Voutr of the reference supply 122 and Voutx of a selected power supply, e.g., power supply 120-x. The offset voltage may be detected by comparing Voutr and Voutx when both the reference supply 122 and selected power supply 120-x are operating at no load, are both supplied by Vin and are both controlled by PWM signal 109 with duty cycle D. The offset voltage may then be determined as Voutx−Voutr. The offset voltage may vary with operating temperature, thus, the calibration operation may be performed at a plurality of operating temperatures.

For example, for each power supply 120-1, 120-2, . . . , 120-n, a present temperature may be set to a first calibration temperature. Input voltage Vin may be supplied to the respective power supply and to the reference supply 122. Controller circuitry 102 may be configured to supply a PWM signal with duty cycle D to the selected power supply and then to the reference supply 122. PS output current logic circuitry 114 may be configured to sequentially capture a scaled Voutx and Voutr from common voltage divider circuitry 106 and to determine a difference between Voutx and Voutr. The operations may be repeated for a second calibration temperature. The offset voltages may then be associated with an appropriate PS ID and stored in LUT 118 for each power supply 120-1, 120-2, . . . , 120-n. Output current logic circuitry 114 may then be configured to adjust (Voutx-Voutr) based, at least in part, on present temperature.

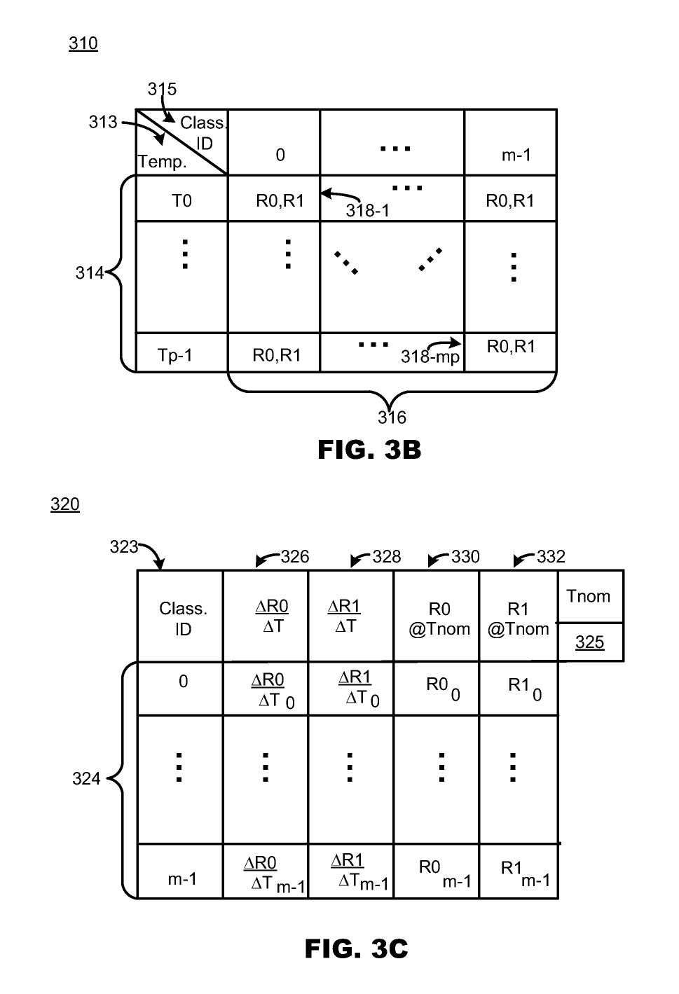

FIG. 3A illustrates a lookup table (LUT) 300 according to one embodiment of the present disclosure. LUT 300 is one example of LUT 118 of FIG. 1. LUT 300 includes classification IDs indexed by PS ID, as described herein. Thus, LUT 300 may include an index column 302 that contains PS IDs, a column 304 that contains classification IDs, a column 306 that contains offset voltages for the first calibration temperature (e.g., VO_T1) and a column 308 that contains offset voltages for the second calibration temperature (e.g., VO_T2). In operation, utilizing LUT 300, an appropriate offset voltage may be selected and/or determined by output current logic circuitry 114 based, at least in part, on PS ID and sensed present temperature. Output current logic circuitry 114 may then be configured to adjust (Voutx-Voutr) by the appropriate offset voltage.

Generally, Reff is related to a topology of the selected power supply 120-x and output power circuitry 126-x. For example, for a Buck DC/DC converter topology and LC output power circuitry, Reff=(Rds_lowside+L_dcr)+D*(Rds_highside−Rds_lowside), where Rds_lowside is the drain-source resistance of a low side power switch, L_dcr is a DC resistance of the inductor circuitry, D is duty cycle and Rds_highside is the drain-source resistance of a high side power switch. In some embodiments, Reff may be approximated as Rds_lowside+L_dcr and D*(Rds_highside−Rds_lowside) may be ignored since, in a typical power supply arrangement, this quantity is much smaller than (Rds_lowside+L_dcr).

Rds_lowside, L_dcr and/or Rds_highside may vary with and/or be related to one or more operational parameter(s) associated with power supply circuitry 104 and/or output power circuitry 126-1, 126-2, . . . , 126-n. For example, Rds_lowside, L_dcr and/or Rds_highside may vary with current operating temperature (“present temperature”). In another example, nominal values and/or temperature sensitivity of Rds_lowside, L_dcr and/or Rds_highside may vary across power devices and thus, Rds_lowside, L_dcr and/or Rds_highside may be related to classification ID. In order to account for variation in Rds_lowside, L_dcr and/or Rds_highside with present temperature and/or classification ID, a lookup table, e.g., LUT 116, may be generated during a calibration operation. For example, LUT 116 may include temperature value(s), a relationship between change in temperature and change in resistance parameter, classification ID(s) and one or more resistance parameter(s). The resistance parameters include R0=Rds_lowside+L_dcr determined for, and associated with, a plurality of classification IDs and a plurality of temperature values. The resistance parameters may further include R1=Rds_highside−Rds_lowside similarly determined for, and associated with, a plurality of classification IDs and a plurality of temperature values. Thus, Reff=R0+D*R1.

FIG. 3B illustrates a lookup table (LUT) 310 according to one embodiment of the present disclosure. LUT 310 is one example of LUT 116 of FIG. 1. LUT 310 may include an index column 313, an index row 315, a plurality of columns 314 and a plurality of rows 316. The index column 313 and index row 315 correspond to operational parameters related to variation in R0 and/or R1 and thereby Reff. For example, the index column 313 may include a number (p) of calibration temperatures and the index row 315 may include a number (m) of classification IDs. Values of the numbers p and m may be selected based, at least in part, on a desired accuracy in the ultimate Ioutx determination. In other words, increasing p and/or m may improve accuracy. The number m may be increased by using a relatively finer granularity (i.e., relatively smaller ranges) in the ranges of values for the selected power device characteristics. LUT 310 further includes at least one field 318-1, . . . , 318-mp at an intersection of each row and each column. The field, e.g., field 318-1, includes the first resistance value R0, determined during calibration at temperature T0 and for classification ID 0. The field 318-1 may include the second resistance value R1 also determined during calibration at temperature T0 and for classification ID 0. Similarly, field 318-mp includes the first resistance value R0 associated with a maximum calibration temperature (Tp−1) and a maximum classification ID (m−1).

Each operating temperature T0, . . . , Tp−1 may have an associated range, for which the associated R0, R1 values are generally constant. For example, an operating temperature range of Tmin to Tmax may be divided into p temperature values T0, . . . , Tp−1. An associated temperature range for each temperature value Ti may then generally correspond to Ti±ΔT. 2ΔT may then correspond to (Tmax−Tmin)/p, T0 may then correspond to Tmin+ΔT and Tp−1 may correspond to Tmax−ΔT. In other words, R0 and R1 are determined for discrete temperature values T0, . . . , Tp−1 while actual operating temperature values (i.e., present temperatures) may be continuous within the range Tmin to Tmax. Thus, ΔT is configured to ensure that a detected present temperature between Tmin and Tmax may be related to R0 and/or R1 by LUT 310. For example, R0 and R1 stored in field 318-1 may correspond to a present temperature in the range T0±ΔT. LUT 310 may be generated during calibration for resistance values whose relationship to temperature may not be linear. LUT 310 is configured to provide a relatively accurate accounting of variation of R0 and/or R1 with temperature at a cost of a relatively more complicated LUT.

FIG. 3C illustrates another lookup table (LUT) 320 according to another embodiment of the present disclosure. LUT 320 is one example of LUT 116 of FIG. 1. LUT 320 may include an index column 323, a plurality of rows 324 and a nominal temperature Tnom 325. For example, the nominal temperature may be 0° C. In another example, the nominal temperature may be 25° C. The index column 323 includes a number (m) of classification IDs. LUT 320 further includes two columns 326, 328 of change in resistance parameter values versus change in temperature values (ΔR0/ΔT and ΔR1/ΔT, respectively), a column 330 corresponding to the first resistance value R0 and a column 332 corresponding to the second resistance value R1.

The nominal temperature 325 may be selected and the respective resistance values in columns 330, 332 may be determined during calibration for each classification ID (0, . . . , m−1) at the nominal temperature 325. The values (i.e., slopes) included in columns 326, 328 may also be determined during calibration for each classification ID. For example, respective resistance values of R0 and R1 may be determined for two temperatures at each classification ID and the slopes may then be calculated as the difference in resistance divided by the difference in temperature.

LUT 320 may be populated for resistance parameters R0, R1 whose variation with temperature is generally linear. In an embodiment, the slopes in columns 326, 328 may be determined during calibration. In another embodiment, the slopes may be provided by a power supply and/or output power circuitry manufacturer, for example, in a specification sheet. LUT 320 may be further simplified if, for example, the change in resistance parameter versus change in temperature relationship does not vary with classification ID. In this example, one ΔR0/ΔT and one ΔR1/ΔT may then be provided for each resistance parameter. In another example, LUT 320 may be further simplified if, for example, the change in resistance parameter versus change in temperature does not vary between resistance parameters. In other words, in this example, ΔR0/ΔT=ΔR1/ΔT, and only one column 326 or 328 may be provided.

FIG. 3D illustrates an example calibration setup 350 used for populating LUTs 310, 320 of FIG. 3B and/or FIG. 3C, consistent with various embodiments of the present disclosure. FIG. 3D illustrates only a portion of power supply system 100. The portion includes power supply and output power circuitry elements that contribute to Reff. Calibration setup 350 corresponds to, for example, power supply 120-x and output power circuitry 126-x with a known calibration load 362 rather than load 130-x coupled to the output power circuitry 126-x.

Calibration setup 350 includes a calibration controller 351, driver circuitry 352, highside switch 354, lowside switch 356, inductance circuitry 358 and capacitance 360. For example, driver circuitry 352 corresponds to driver circuitry 202 and switches 354, 356 correspond to switches 204, 206, of FIG. 2. Vin is coupled to the drain of the highside switch 354. The source of highside switch is coupled to the inductance circuitry 358 and to the drain of the lowside switch 356. The source of the lowside switch 356 is coupled to Vss. The gates of the highside switch 354 and the lowside switch 356 are coupled to the driver circuitry 352. Calibration setup 350 is configured to receive a PWM signal from calibration controller 351.

For calibration operations, a number of samples of power devices (i.e., power supplies and associated output power circuitry) may be selected for each of the plurality of classification IDs. For each sample, the calibration load 362 is set to a known, fixed load current, Iload. For example, Iload may be set to one ampere (A). A target calibration temperature may be set and/or detected and Vin may be applied. A PWM input may be set to zero (i.e., D=0). Thus, the lowside switch 356 may be ON and the highside switch 354 may be OFF. Vout may be measured and a differential voltage (Vss−Vout) may be determined and/or the differential voltage (Vss−Vout) may be measured directly. The first resistance parameter, R0, may then be determined as: (Vss−Vout)/Iload=Rds_lowside+L_dcr=R0. The PWM input may then be set to one (i.e., D=1). Thus, the lowside switch 356 may be OFF and the highside switch 354 may be on. Vout may be measured and a differential voltage (Vin−Vout) may be determined and/or the differential voltage (Vin−Vout) may be measured directly. An intermediate resistance Rint may then be determined as Rint=(Vin−Vout)/Iload. The second resistance parameter, R1, may then be determined as: Rint−R0=((Vin−Vout)/Iload)−((Vss−Vout)/Iload)=(Rds_highside+L_dcr)−(Rds_lowside+L_dcr)=Rds_highside−Rds_lowside=R1. The operations may be repeated at different temperatures for each sample and thus the range of classification IDs in order to populate the resistance parameter values R0, R1 in LUT 310 and/or LUT 320. For LUTs that includes slope values, ΔR0/ΔT and/or ΔR1/ΔT may be determined. Thus, LUTs 310, 320 may be populated by applying a known load current Iload, setting and applying Vin and detecting at least Vout.

In operation, output current logic circuitry 114 may be configured to select appropriate resistance parameter(s) from LUT 116 based, at least in part, on a present temperature and/or a classification ID for a selected power supply 120-x. Output current logic circuitry 114 may be configured to determine a classification ID for a respective power supply based, at least in part, on associated PS ID and utilizing LUT 118. Output current logic circuitry 114 may then be configured to determine a present value for output current Ioutx. Accuracy of the determined Ioutx may then be enhanced based, at least in part, on detected D*Vinx (that may be adjusted for offset voltage, as described herein) and based, at least in part, on Reffx that accounts for variation in Reffx due to variation in present temperature and/or variation in resistance parameter sensitivity across a plurality of classification IDs.

Turning again to FIG. 1, in operation, power supply selection circuitry 112 may generate a command to power supply logic circuitry 124 to select a power supply (e.g., power supply 120-x) among the plurality of power supplies 120-1, 120-2, . . . , 120-n (operating at a duty cycle Dx) to couple an output voltage 123-1, 123-2, . . . , or 123-n, e.g., output voltage 123-x, to bus 121 and to common voltage divider circuitry 106, thus supplying Voutx to the common voltage divider circuitry 106. In addition, power supply selection circuitry 112 may generate a command to power supply logic circuitry 124 to gather a present temperature of the selected power supply 120-x. If the PS ID and the associated classification ID for the selected power supply are not included in LUT 118, power supply selection circuitry 114 may generate a command to power supply logic circuitry 124 to provide the PS ID and the associated classification ID for the selected power supply. The PS ID and associated classification ID may then be stored in LUT 118.

Output current logic circuitry 114 may be configured to receive the scaled Voutx from the common voltage divider circuitry 106 and to digitize the scaled output voltage. Output current logic circuitry 114 may be further configured to store the scaled output voltage (e.g., over several cycles of the PWM/PFM signal) and the present temperature. Before or after selection of a power supply 120-1, 120-2, . . . , 120-n, the power supply selection circuitry 112 may also generate a command to the PWM MUX circuitry 110 to couple the PWM signal of the selected (or soon-to-be selected) power supply 120-x to the reference supply circuitry 122, so that reference supply circuitry 122 can be operated using a PWM signal having a duty cycle Dx, i.e., the same duty cycle as the selected power supply 120-x.

The power supply selection circuitry 112 may also generate a command to the power supply logic circuitry 124 to select the reference supply circuitry 122 to couple an output voltage 129 to bus 121 and to common voltage divider circuitry 106, thus supplying scaled Voutr to the output current logic circuitry 114. Output current logic circuitry 114 may be configured to receive the scaled Voutr from the common voltage divider circuitry and to digitize the scaled reference voltage. Output current logic circuitry 114 may be configured to store the scaled reference voltage (e.g., over several cycles of the PWM/PFM signal). Output current logic circuitry 114 may be configured to request a present temperature from, e.g., PS logic circuitry 124, and to determine an offset voltage based, at least in part, on the present temperature, PS ID and associated offset voltages stored in LUT 118. Output current logic circuitry 114 may then be configured to average the output voltage and the reference voltage over the several cycles. Output current logic circuitry 114 may then adjust (Voutx-Voutr) based, at least in part, on the determined offset voltage. Output current logic circuitry 114 may then be configured to determine a difference Voutr-Voutx that corresponds to D*Vinx−Voutx.

Output logic circuitry 114 may then be configured to select at least R0 (i.e., the first resistance parameter) and possibly R1 (i.e., the second resistance parameter) for power supply 120-x from LUT 116 based, at least in part, on the stored present temperature and based, at least in part, on the classification ID associated with the selected power supply 120-x. For example, output current logic circuitry 114 may be configured determine the appropriate classification ID by searching LUT 118 using the PS ID of the selected power supply as index. Output current logic circuitry 114 may then be configured select and/or determine R0 and/or R1 by searching LUT 116 using the classification ID associated with the selected power supply 120-x and the present temperature. Output logic circuitry 114 may then be configured to determine Ioutx. The operations may be repeated for the other power supplies so that Ioutx may be determined, sequentially, for each power supply 120-1, 120-2, . . . , 120-n.

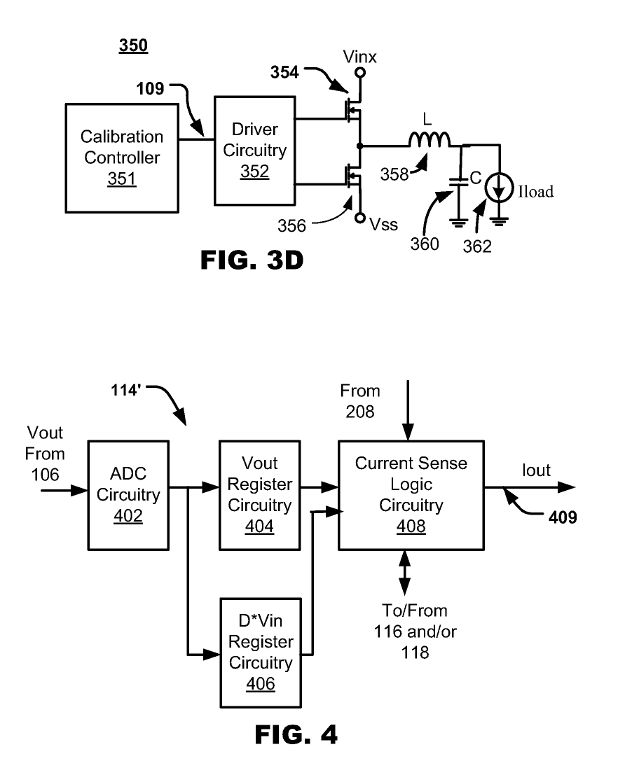

FIG. 4 illustrates an example output current logic circuitry 114′ according to one embodiment of the present disclosure. Output current logic circuitry 114′ is one example of output current logic circuitry 114 of FIG. 1. Output current logic circuitry 114′ is configured to receive a scaled voltage, corresponding to Voutx and/or Voutr, from common voltage divider circuitry 106, to determine an output current Ioutx 409, based at least in part, on Voutx and/or Voutr. Ioutx may then be provided to controller circuitry 102 that may then be configured to adjust and/or maintain control of the selected power supply based, at least in part, on Ioutx.

Output current logic circuitry 114′ includes ADC (analog-to-digital converter) circuitry 402, Vout register circuitry 404, D*Vin register circuitry 406 and current sense logic circuitry 408. ADC circuitry 402 is configured to receive a scaled input voltage, e.g., Voutx and/or Voutr, scaled by common voltage divider circuitry 106 and to convert the scaled input voltage from an analog signal to a digital representation of the scaled input voltage. For example, ADC circuitry 402 may include a sigma-delta ADC, etc. A sigma-delta ADC may exhibit relatively high resolution and relatively low power consumption and may be relatively low cost. Of course, sigma-delta ADC is only an example ADC and other ADCs that are relatively high resolution and relatively low power may be utilized consistent with the present disclosure.

Registers 404, 406 are configured to receive digital representations (i.e., samples) of scaled Voutx and Voutr, respectively. Registers 404, 406 may each be configured to accumulate (i.e. sum) a respective number, n, samples of Voutx and Voutr and to divide the sums by n. Thus, resolution of the digital representation of scaled Vout and Voutr may be improved relative to a single sample. Such sampling and averaging may further provide improved noise rejection. In an example embodiment, one register circuitry may be implemented configured to accumulate and add n values of Voutr (corresponding to D*Vin) and to subtract the n values of Voutx.

Registers 404, 406 may then be configured to provide the averaged digital representation of scaled Vout and Voutr to current sense logic circuitry 408. Current sense logic circuitry 408 may then be configured to receive operational information from, e.g., switch sensor circuitry 208 of FIG. 2. For example, the operational information may include a present temperature. Current sense logic circuitry 408 may then be configured to access LUT 118 to determine the classification ID associated with power supply 120-x. Current sense logic circuitry 408 may then be configured to access LUT 116 to determine resistance parameter R0 (and possibly R1) that corresponds to the present temperature and classification ID. Current sense logic circuitry 408 may then be configured to determine Reffx based, at least in part, on R0. In some embodiments, current sense logic circuitry 408 may be configured to determine Reffx based, at least in part, on both R0 and R1. Current sense logic circuitry 408 may then determine Ioutx based, at least in part, on Voutx, Voutr=D*Vin and Reffx as Ioutx=(Voutr−Voutx)/Reffx.

Thus, variation, if any, in Voutr and/or variation in Reffx with at least temperature may be accounted for in determining Ioutx. Further, error due to mismatch in voltage divider circuitry may be avoided and increased pin count of power supply circuitry 104 and/or controller circuitry 102 may be avoided.

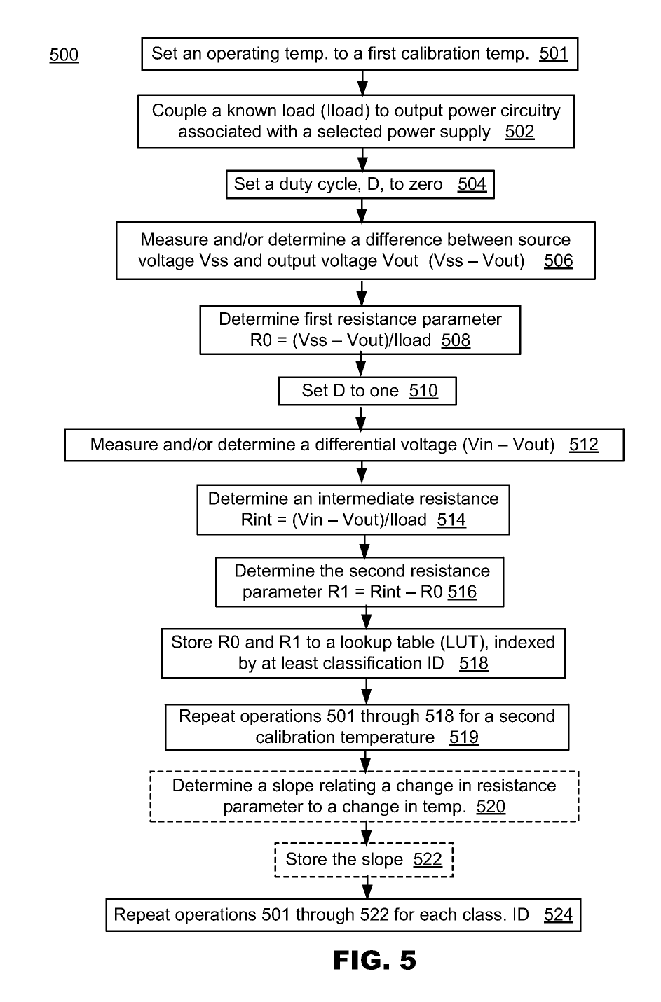

FIG. 5 is a flowchart of calibration operations 500 according to one embodiment of the present disclosure. In particular, the flowchart 500 illustrates one example embodiment of operations for determining resistance parameters R0, R1 as a function of present temperature and/or classification ID. The operations of flowchart 500 may be performed, for example, by controller circuitry 102.

Operations of this embodiment include setting an operating temperature to a first calibration temperature 501. Operations may also include coupling a known load (Iload) to output power circuitry associated with a selected power supply 502. Operations may also include setting a duty cycle, D, to zero 504. A difference between source voltage Vss and output voltage Vout (Vss−Vout) may be measured and/or determined at operation 506. R0 may be determined at operation 508 as (Vss−Vout)/Iload. D may be set to one at operation 510. A differential voltage (Vin−Vout) may be measured and/or determined at operation 512. An intermediate resistance Rint may be determined at operation 514 as (Vin−Vout)/Iload. The second resistance parameter R1 may then be determined at operation 516 as the R1=Rint−R0. Operation 518 includes storing R0 and R1 to a lookup table (LUT), indexed by at least classification ID. Operation 519 includes repeating operations 501 through 518 for a second calibration temperature. In some embodiments, operation 520 may include determining a slope relating a change in resistance parameter to a change in temperature. The slope may be stored at operation 522. Operation 524 includes repeating operations 501 through 522 for each classification ID.

Thus, a LUT may be populated for a plurality of operating temperatures and a plurality of classification IDs. The LUT may then include resistance parameters associated with the operating temperatures and classification IDs.

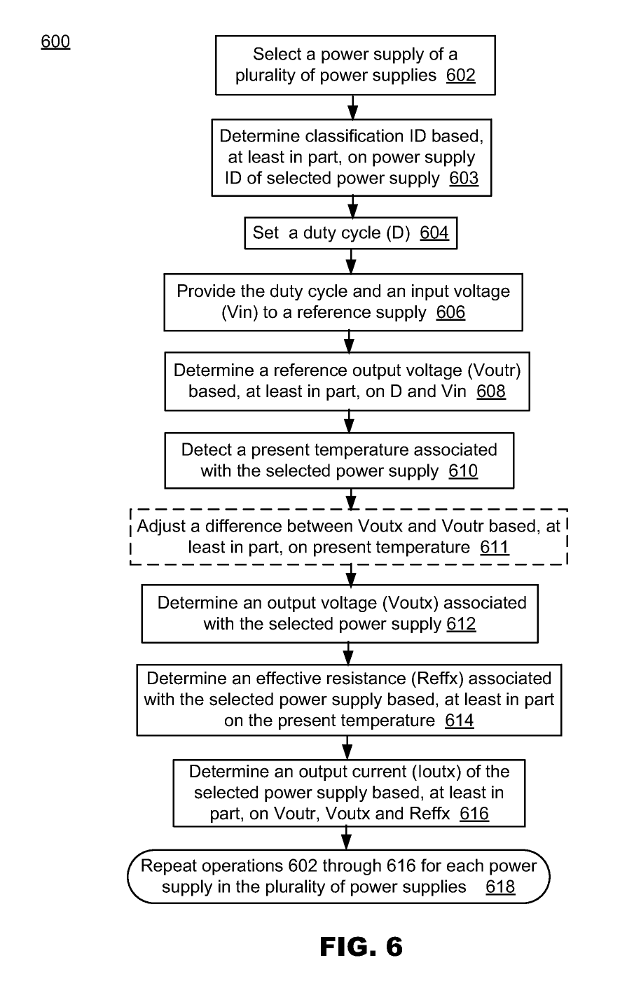

FIG. 6 is a flowchart of current sense operations 600 according to one embodiment of the present disclosure. In particular, the flowchart 600 illustrates one example embodiment of operations for sensing a load current, as described herein. The operations of flowchart 600 may be performed, for example, by controller circuitry 102.

Operations of this embodiment include selecting a power supply of a plurality of power supplies 602. Operations according to this embodiment also include determining a classification ID based, at least in part, on a PS ID associated with the selected power supply 603. A duty cycle (D) may be set at operation 604. Operation 606 includes providing the duty cycle and an input voltage (Vin) to a reference supply. Operation 608 includes determining a reference output voltage (Voutr) based, at least in part, on D and Vin. Operation 610 includes detecting a present temperature associated with the selected power supply. In some embodiments, a difference between Voutx and Voutr may be adjusted based, at least in part, on present temperature at operation 611. Operation 612 includes determining an output voltage (Voutx) associated with the selected power supply. Operation 614 includes determining an effective resistance (Reffx) associated with the selected power supply based, at least in part on the present temperature. Operation 616 includes determining an output current (Ioutx) of the selected power supply based, at least in part, on Voutr, Voutx and Reffx. Operations 602 through 616 of flowchart 600 may be repeated for each power supply in the plurality of power supplies at operation 618.

Thus, a relatively accurate output (i.e., load) current sensing for a plurality of power supplies may be performed. Variation in Reff for a selected power supply and/or associated output power circuitry with operating temperature and/or classification ID, may be accommodated.

While the flowcharts of FIGS. 5 and 6 illustrate operations according various embodiments, it is to be understood that not all of the operations depicted in FIGS. 5 and/or 6 are necessary for other embodiments. In addition, it is fully contemplated herein that in other embodiments of the present disclosure, the operations depicted in FIGS. 5 and/or 6, and/or other operations described herein may be combined in a manner not specifically shown in any of the drawings, and such embodiments may include less or more operations than are illustrated in FIGS. 5 and/or 6. Thus, claims directed to features and/or operations that are not exactly shown in one drawing are deemed within the scope and content of the present disclosure.

Memory may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a system that includes one or more storage devices having stored thereon, individually or in combination, instructions that when executed by one or more processors perform the methods. The processor may include, for example, a processing unit and/or programmable circuitry. The storage device may include a machine readable storage medium including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Bus 113, 115 and/or bus 121 may comply or be compatible with one or more bus protocols. The bus protocols include, but are not limited to, I2C (Inter-integrated circuit) bus, SMBus (System Management bus) and/or PMBus™ (Power Management bus). The I2C bus protocol may comply or be compatible with Revision 6 of the I2C-bus specification published by NXP Semiconductors N.V., titled “UM10204 I²C-bus specification and user manual”, published in April 2014 and/or other versions of this specification. The SMBus protocol may comply or be compatible with Version 2.0 of the SMBus specification published by SBS Implementers Forum, titled “System Management Bus (SMBus) Specification”, published in August 2003 and/or other versions of this specification. The PMBus™ protocol may comply or be compatible with Version 1.2x of the PMBus™ specification titled “PMBus™ Power System Management Protocol Specification Part 1—General Requirements, Transport and Electrical Interface” and/or Version 1.2 of the PMBus™ specification titled “PMBus™ Power System Management Protocol Specification Part 2—Command Language”, both published by the System Management Interface Forum, Inc. in September 2010 and/or other versions of these specifications, for example, version 1.3, presented September 2013.

Thus, a system, method and apparatus, as described herein, are configured to provide relatively accurate output (i.e., load) current sensing for a plurality of power supplies. Voutr is configured to provide present value of D*Vin to account for any variation in Vin and to thus improve accuracy of the Ioutx determination. Reffx determination based, at least in part, on calibration data included in the LUT, detected temperature and/or classification ID is configured to further improve accuracy by accounting for variation in Reffx due to temperature and/or related to classification ID. Utilizing common voltage divider circuitry for all sensed voltages Voutx, Voutr eliminates mismatch in resistor values that may be associated with individual voltage divider circuitries and that may affect the accuracy of sensed current. Coupling the common voltage divider circuitry to the controller may be accomplished by a relatively small number of pins (e.g., one or two), thus, avoiding significantly increasing the pin counts of the controller and the power supply ICs.

### EXAMPLES

Examples of the present disclosure include subject material such as a method, means for performing acts of the method, a device, at least one machine-readable medium, including instructions that when performed by a machine cause the machine to perform acts of the method, or of an apparatus or system to sense current in a power supply system, as discussed below.

### Example 1

According to this example there is provided an apparatus including controller circuitry to select a first power supply of a plurality of power supplies, determine a reference output voltage (Voutr) associated with a reference supply based, at least in part, on a duty cycle (D) and an input voltage (Vin), D and Vin related to the first power supply. The controller circuitry is further to determine an output voltage (Voutx) associated with the first power supply, determine an effective resistance (Reffx) associated with the first power supply based, at least in part, on a present temperature, and determine an output current (Ioutx) associated with the first power supply based, at least in part, on Voutr, Voutx and Reffx.

### Example 2

This example includes the elements of example 1, wherein the controller circuitry is further to detect the present temperature associated with the first power supply.

### Example 3

This example includes the elements of example 1, wherein the controller circuitry includes a first lookup table (LUT) and the controller circuitry is further to select a resistance parameter value from the first LUT based, at least in part, on the present temperature, Reffx related to the resistance parameter.

### Example 4

This example includes the elements of example 1, wherein the controller circuitry is further to receive a scaled Voutx and a scaled Voutr from a same voltage divider circuitry.

### Example 5

This example includes the elements of any one of examples 1 through 4, wherein the controller circuitry is further to select a second power supply and to determine an output current associated with the second power supply.

### Example 6

This example includes the elements of any one of examples 1 through 4, wherein the controller circuitry is further to adjust a difference between Voutx and Voutr based, at least in part, on the present temperature.

### Example 7

This example includes the elements of example 3, wherein the first LUT includes a plurality of resistance parameter values indexed by at least one of the present temperature and a classification identifier (ID).

### Example 8

This example includes the elements of any one of examples 1 through 4, wherein Reffx is related to a classification identifier (ID), the classification ID associated with the first power supply.

### Example 9

This example includes the elements of example 6, wherein the difference between Voutx and Voutr is adjusted with the reference supply operating in a no-load condition.

### Example 10

This example includes the elements of any one of examples 1 through 4, wherein Ioutx is determined as Ioutx=(Voutr−Voutx)/Reffx.

### Example 11

This example includes the elements of any one of examples 1 through 4, wherein the controller circuitry further includes a second LUT, and the controller circuitry is further to select an offset voltage from the second LUT based, at least in part, on a power supply identifier (PS ID) associated with the first power supply and to adjust a difference between Voutx and Voutr based, at least in part, on the selected offset voltage.

### Example 12

This example includes the elements of any one of examples 1 through 4, wherein Reffx is determined based, at least in part, on a first resistance parameter, R0.

### Example 13

This example includes the elements of example 12, wherein Reffx is determined based, at least in part, on a second resistance parameter, R1.

### Example 14

This example includes the elements of example 3, wherein the first LUT is populated based, at least in part, on calibration data.

### Example 15

This example includes the elements of example 3, wherein the first LUT includes a plurality of entries, each entry indexed by a classification identifier.

### Example 16

This example includes the elements of example 15, wherein at least some of the plurality of entries include a change in resistance parameter value versus a change in operating temperature.

### Example 17

This example includes the elements of any one of examples 15 or 16, wherein at least some of the plurality of entries include a resistance parameter value related to an operating temperature.

### Example 18

This example includes the elements of any one of examples 1 through 4, wherein the first power supply corresponds to a Buck converter.

### Example 19

According to this example there is provided a method. The method includes selecting, by controller circuitry, a first power supply of a plurality of power supplies; determining, by the controller circuitry, a reference output voltage (Voutr) associated with a reference supply based, at least in part, on a duty cycle (D) and an input voltage (Vin), D and Vin related to the first power supply; determining, by the controller circuitry, an output voltage (Voutx) associated with the first power supply; determining, by the controller circuitry, an effective resistance (Reffx) associated with the first power supply based, at least in part, on a present temperature; and determining, by the controller circuitry, an output current (Ioutx) associated with the first power supply based, at least in part, on Voutr, Voutx and Reffx.

### Example 20

This example includes the elements of example 19, and further includes detecting, by the controller circuitry, the present temperature associated with the first power supply.

### Example 21

This example includes the elements of example 19, and further includes selecting, by the controller circuitry, a resistance parameter value from a first lookup table (LUT) based, at least in part, on the present temperature, Reffx related to the resistance parameter.

### Example 22

This example includes the elements of example 19, and further includes receiving, by the controller circuitry, a scaled Voutx and a scaled Voutr from a same voltage divider circuitry.

### Example 23

This example includes the elements of example 19, and further includes selecting, by the controller circuitry, a second power supply; and determining, by the controller circuitry, an output current associated with the second power supply.

### Example 24

This example includes the elements of example 19, and further includes adjusting, by the controller circuitry, a difference between Voutx and Voutr based, at least in part, on the present temperature.

### Example 25

This example includes the elements of example 21, wherein the first LUT includes a plurality of resistance parameter values indexed by at least one of the present temperature and a classification identifier (ID).

### Example 26

This example includes the elements of example 19, wherein Reffx is related to a classification identifier (ID), the classification ID associated with the first power supply.

### Example 27

This example includes the elements of example 27, wherein the difference between Voutx and Voutr is adjusted with the reference supply operating in a no-load condition.

### Example 28

This example includes the elements of example 19, wherein Ioutx is determined as Ioutx=(Voutr−Voutx)/Reffx.

### Example 29

This example includes the elements of example 21, wherein the controller circuitry further includes a second LUT. This example further includes selecting, by the controller circuitry, an offset voltage from the second LUT based, at least in part, on a power supply identifier (PS ID) associated with the first power supply and adjusting, by the controller circuitry, a difference between Voutx and Voutr based, at least in part, on the selected offset voltage.

### Example 30

This example includes the elements of example 19, wherein Reffx is determined based, at least in part, on a first resistance parameter, R0.

### Example 31

This example includes the elements of example 30, wherein Reffx is determined based, at least in part, on a second resistance parameter, R1.

### Example 32

This example includes the elements of example 21, wherein the first LUT is populated based, at least in part, on calibration data.

### Example 33

This example includes the elements of example 21, wherein the first LUT includes a plurality of entries, each entry indexed by a classification identifier.

### Example 34

This example includes the elements of example 33, wherein at least some of the plurality of entries include a change in resistance parameter value versus a change in operating temperature.

### Example 35

This example includes the elements of example 33, wherein at least some of the plurality of entries include a resistance parameter value related to an operating temperature.

### Example 36

This example includes the elements of example 19, wherein the first power supply corresponds to a Buck converter.

### Example 37

According to this example there is provided a computer-readable storage device having stored thereon instructions that when executed by one or more processors result in the following operations including: selecting a first power supply of a plurality of power supplies; determining a reference output voltage (Voutr) associated with a reference supply based, at least in part, on a duty cycle (D) and an input voltage (Vin), D and Vin related to the first power supply; determining an output voltage (Voutx) associated with the first power supply; determining an effective resistance (Reffx) associated with the first power supply based, at least in part, on a present temperature; and determining an output current (Ioutx) associated with the first power supply based, at least in part, on Voutr, Voutx and Reffx.

### Example 38

This example includes the elements of example 37, wherein the instructions that when executed by one or more processors results in the following additional operations including: detecting the present temperature associated with the first power supply.

### Example 39

This example includes the elements of example 37, wherein the instructions that when executed by one or more processors results in the following additional operations including: selecting a resistance parameter value from a first lookup table (LUT) based, at least in part, on the present temperature, Reffx related to the resistance parameter.

### Example 40

This example includes the elements of example 37, wherein the instructions that when executed by one or more processors results in the following additional operations including: receiving a scaled Voutx and a scaled Voutr from a same voltage divider circuitry.

### Example 41

This example includes the elements of any one of examples 37 through 40, wherein the instructions that when executed by one or more processors results in the following additional operations including: selecting a second power supply and determining an output current associated with the second power supply.

### Example 42

This example includes the elements of any one of examples 37 through 40, wherein the instructions that when executed by one or more processors results in the following additional operations including: adjusting a difference between Voutx and Voutr based, at least in part, on the present temperature.

### Example 43

This example includes the elements of example 39, wherein the first LUT includes a plurality of resistance parameter values indexed by at least one of the present temperature and a classification identifier (ID).

### Example 44

This example includes the elements of any one of examples 37 through 40, wherein Reffx is related to a classification identifier (ID), the classification ID associated with the first power supply.

### Example 45

This example includes the elements of example 42, wherein the difference between Voutx and Voutr is adjusted with the reference supply operating in a no-load condition.

### Example 46

This example includes the elements of any one of examples 37 through 40, wherein Ioutx is determined as Ioutx=(Voutr−Voutx)/Reffx.

### Example 47

This example includes the elements of any one of examples 37 through 40, wherein the instructions that when executed by one or more processors results in the following additional operations including: selecting an offset voltage from a second LUT based, at least in part, on a power supply identifier (PS ID) associated with the first power supply; and adjusting a difference between Voutx and Voutr based, at least in part, on the selected offset voltage.

### Example 48

This example includes the elements of any one of examples 37 through 40, wherein Reffx is determined based, at least in part, on a first resistance parameter, R0.

### Example 49

This example includes the elements of example 48, wherein Reffx is determined based, at least in part, on a second resistance parameter, R1.

### Example 50

This example includes the elements of example 39, wherein the first LUT is populated based, at least in part, on calibration data.

### Example 51

This example includes the elements of example 39, wherein the first LUT includes a plurality of entries, each entry indexed by a classification identifier.

### Example 52

This example includes the elements of example 51, wherein at least some of the plurality of entries include a change in resistance parameter value versus a change in operating temperature.

### Example 53

This example includes the elements of example 51, wherein at least some of the plurality of entries include a resistance parameter value related to an operating temperature.

### Example 54

This example includes the elements of any one of examples 37 through 40, wherein the first power supply corresponds to a Buck converter.

### Example 55

According to this example there is provided a computer readable storage device having stored thereon instructions that when executed by one or more processors result in the following operations including: the method according to any one of examples 19 to 36.

### Example 56

Another example of the present disclosure is a system including at least one device arranged to perform the method of any one of examples 19 to 36.

### Example 57

Another example of the present disclosure is a device including means to perform the method of any one of examples 19 to 36.

### Example 58

According to this example there is provided a system. The system includes controller circuitry; power supply circuitry including a plurality of power supplies and a reference supply; a plurality of output power circuitries, each power supply coupled to a respective output power circuitry; a reference output power circuitry coupled to the reference supply; and common voltage divider circuitry to selectively couple each respective power supply and the reference supply to the controller circuitry. The controller circuitry is to select a first power supply of the plurality of power supplies, determine a reference output voltage (Voutr) of the reference output power circuitry based, at least in part, on a duty cycle (D) and an input voltage (Vin), D and Vin related to the first power supply. The controller circuitry is further to determine an output voltage (Voutx) of a first output power circuitry associated with the first power supply, determine an effective resistance (Reffx) associated with the first power supply and the first output power circuitry based, at least in part, on a present temperature, and determine an output current (Ioutx) associated with the first power supply based, at least in part, on Voutr, Voutx and Reffx.

### Example 59

This example includes the elements of example 58, wherein the controller circuitry is further to detect the present temperature associated with the first power supply.

### Example 60

This example includes the elements of example 58, wherein the controller circuitry includes a lookup table (LUT) and the controller circuitry is further to select a resistance parameter value from the LUT based, at least in part, on the present temperature, Reffx related to the resistance parameter.

### Example 61

This example includes the elements of example 58, wherein the common voltage divider circuitry is to receive Voutx and Voutr, sequentially, and to provide a scaled Voutx and a scaled Voutr, sequentially, to the controller circuitry.

### Example 62

This example includes the elements of any one of examples 58 through 61, wherein the common voltage divider circuitry is coupled to the plurality of power supplies and the reference supply by a bus.

### Example 63

This example includes the elements of any one of examples 58 through 61, wherein the controller circuitry is further to adjust a difference between Voutx and Voutr based, at least in part, on the present temperature.

### Example 64

This example includes the elements of example 60, wherein the LUT includes a plurality of resistance parameter values indexed by at least one of the present temperature and a classification identifier (ID).

### Example 65

This example includes the elements of any one of examples 58 through 61, wherein Reffx is related to a classification identifier (ID), the classification ID associated with the first power supply.

### Example 66

This example includes the elements of example 63, wherein the difference between Voutx and Voutr is adjusted with the reference supply operating in a no-load condition.

### Example 67

This example includes the elements of any one of examples 58 through 61, wherein Ioutx is determined as Ioutx=(Voutr−Voutx)/Reffx.

### Example 68

This example includes the elements of any one of examples 58 through 61, wherein the controller circuitry further includes a second LUT, and the controller circuitry is further to select an offset voltage from the second LUT based, at least in part, on a power supply identifier (PS ID) associated with the first power supply and to adjust a difference between Voutx and Voutr based, at least in part, on the selected offset voltage.

### Example 69

This example includes the elements of any one of examples 58 through 61, wherein Reffx is determined based, at least in part, on a first resistance parameter, R0.

### Example 70

This example includes the elements of example 69, wherein Reffx is determined based, at least in part, on a second resistance parameter, R1.

### Example 71

This example includes the elements of example 60, wherein the first LUT is populated based, at least in part, on calibration data.

### Example 72

This example includes the elements of any one of examples 58 through 61, wherein the first power supply corresponds to a Buck converter.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. An apparatus comprising:
controller circuitry to select a first power supply of a plurality of power supplies, determine a reference output voltage (Voutr) associated with a reference supply based, at least in part, on a duty cycle (D) and an input voltage (Vin), D and Vin related to the first power supply;
the controller circuitry further to determine an output voltage (Voutx) associated with the first power supply, determine an effective resistance (Reffx) associated with the first power supply based, at least in part, on a present temperature, and determine an output current (Ioutx) associated with the first power supply based, at least in part, on Voutr, Voutx and Reffx.

2. The apparatus of claim 1, wherein the controller circuitry is further to detect the present temperature associated with the first power supply.

3. The apparatus of claim 1, wherein the controller circuitry comprises a lookup table (LUT) and the controller circuitry is further to select a resistance parameter value from the LUT based, at least in part, on the present temperature, Reffx related to the resistance parameter.

4. The apparatus of claim 1, wherein the controller circuitry is further to receive a scaled Voutx and a scaled Voutr from a same voltage divider circuitry.

5. The apparatus of claim 1, wherein the controller circuitry is further to select a second power supply and to determine an output current associated with the second power supply.

6. The apparatus of claim 1, wherein the controller circuitry is further to adjust a difference between Voutx and Voutr based, at least in part, on the present temperature.

7. The apparatus of claim 3, wherein the LUT comprises a plurality of resistance parameter values indexed by at least one of the present temperature and a classification identifier (ID).

8. A method comprising:
selecting, by controller circuitry, a first power supply of a plurality of power supplies;
determining, by the controller circuitry, a reference output voltage (Voutr) associated with a reference supply based, at least in part, on a duty cycle (D) and an input voltage (Vin), D and Vin related to the first power supply;
determining, by the controller circuitry, an output voltage (Voutx) associated with the first power supply;
determining, by the controller circuitry, an effective resistance (Reffx) associated with the first power supply based, at least in part, on a present temperature; and
determining, by the controller circuitry, an output current (Ioutx) associated with the first power supply based, at least in part, on Voutr, Voutx and Reffx.

9. The method of claim 8, further comprising:
detecting, by the controller circuitry, the present temperature associated with the first power supply.

10. The method of claim 8, further comprising:
selecting, by the controller circuitry, a resistance parameter value from a lookup table (LUT) based, at least in part, on the present temperature, Reffx related to the resistance parameter.

11. The method of claim 8, further comprising:
receiving, by the controller circuitry, a scaled Voutx and a scaled Voutr from a same voltage divider circuitry.

12. The method of claim 8, further comprising:
selecting, by the controller circuitry, a second power supply; and
determining, by the controller circuitry, an output current associated with the second power supply.

13. The method of claim 8, further comprising:
adjusting, by the controller circuitry, a difference between Voutx and Voutr based, at least in part, on the present temperature.

14. The method of claim 10, wherein the LUT comprises a plurality of resistance parameter values indexed by at least one of the present temperature and a classification identifier (ID).

15. A system comprising:
controller circuitry;
power supply circuitry comprising a plurality of power supplies and a reference supply;
a plurality of output power circuitries, each power supply coupled to a respective output power circuitry;
a reference output power circuitry coupled to the reference supply; and
common voltage divider circuitry to selectively couple each respective power supply and the reference supply to the controller circuitry,
the controller circuitry to select a first power supply of the plurality of power supplies, determine a reference output voltage (Voutr) of the reference output power circuitry based, at least in part, on a duty cycle (D) and an input voltage (Vin), D and Vin related to the first power supply;
the controller circuitry further to determine an output voltage (Voutx) of a first output power circuitry associated with the first power supply, determine an effective resistance (Reffx) associated with the first power supply and the first output power circuitry based, at least in part, on a present temperature, and determine an output current (Ioutx) associated with the first power supply based, at least in part, on Voutr, Voutx and Reffx.

16. The system of claim 15, wherein the controller circuitry is further to detect the present temperature associated with the first power supply.

17. The system of claim 15, wherein the controller circuitry comprises a lookup table (LUT) and the controller circuitry is further to select a resistance parameter value from the LUT based, at least in part, on the present temperature, Reffx related to the resistance parameter.

18. The system of claim 15, wherein the common voltage divider circuitry is to receive Voutx and Voutr, sequentially, and to provide a scaled Voutx and a scaled Voutr, sequentially, to the controller circuitry.

19. The system of claim 15, wherein the common voltage divider circuitry is coupled to the plurality of power supplies and the reference supply by a bus.

20. The system of claim 15, wherein the controller circuitry is further to adjust a difference between Voutx and Voutr based, at least in part, on the present temperature.

21. The system of claim 17, wherein the LUT comprises a plurality of resistance parameter values indexed by at least one of the present temperature and a classification identifier (ID).
